(19) United States
(12) Patent Application Publication
(10) Pub. No.: US 2010/0003942 A1
(43) Pub. Date: Jan. 7, 2010

(54) LOOP ANTENNA INPUT CIRCUIT FOR AM AND AM RADIO RECEIVER USING THE SAME

(76) Inventors: Takeshi Ikeda, Tokyo (JP); Hiroshi Miyagi, Kanagawa (JP)

Correspondence Address: CONNOLLY BOVE LODGE & HUTZ LLP, 1875 EYE STREET, N.W., SUITE 1100, WASHINGTON, DC, 20006, US

(21) Appl. No.: 12/442,846

(22) PCT Filed: Sep. 19, 2007
(86) PCT No.: PCT/JP2007/068740

§ 371 Date: Mar. 25, 2009

(30) Foreign Application Priority Data
Sep. 26, 2006 (JP) 2006-260058

(51) Int. Cl. H04B 1/06; H01Q 7/00

(52) U.S. Cl. 455/269; 343/866

(57) ABSTRACT

p-MOSFETs (21) and (22) are used as amplifying elements for amplifying a signal input from a loop antenna (1) and are directly connected to the loop antenna (1). Thus, the signal input from the loop antenna (1) can be received in a high impedance through the p-MOSFETs (21) and (22). Consequently, a transformer for carrying out a conversion into a high impedance or the like is not required, and furthermore, the impedance of the loop antenna 1 itself does not need to be increased, thereby suppressing the occurrence of a current noise.

### TECHNICAL FIELD

The present invention relates to a loop antenna input circuit for AM and an AM radio receiver using the same, and more particularly to an AM radio receiver using a loop antenna as an antenna.

### BACKGROUND ART

An antenna to be used in a broadcasting signal receiving device such as a radio receiver includes a loop antenna. The loop antenna is based on a principle for extracting an induced electromotive force depending on a change in a magnetic field in a coil formed by winding a conductor several times. For example, in an AM radio receiver for a home audio, a loop antenna input circuit includes a tuning transformer constituted by a primary coil and a secondary coil coupled electromagnetically thereto and a variable capacitance diode and a capacitor which are connected in parallel with the primary coil.

FIG. 1 is a diagram showing a part of a structure of a conventional AM radio receiver using a loop antenna. In FIG. 1, 101 denotes a loop antenna, 102 denotes a transformer using coils, 103 denotes a variable capacitance diode, 104 denotes a capacitor, 105 denotes an LNA (Low Noise Amplifier), and 106 denotes an input terminal of a control voltage for the variable capacitance diode 103.

A radio frequency signal (an RF signal) having a tuning frequency which is resonated by a resonance circuit formed together with the variable capacitance diode 103 in the RF signals received through the loop antenna 101 is impedance-converted by the transformer 102 and the signal thus converted is supplied to the LNA 105. In the LNA 105, the RF signal is amplified with a low noise and is then supplied to a frequency converter in a subsequent stage which is not shown.

In the conventional AM radio receiver using the loop antenna 101, thus, the transformer 102 and the variable capacitance diode 103 have been used for the impedance conversion. The impedance conversion is carried out for the following reason. Since the loop antenna 101 has a low impedance (several hundreds Ω) and a tuning effect is small (a great Q value cannot be obtained) in that condition, it is necessary to take impedance matching with a variable capacitance device.

There has been known an on-vehicle radio receiver using a dipole antenna in which a field effect transistor (FET) is used as an amplifying element for amplifying a signal input from the antenna (for example, see Patent Document 1). With a structure described in the Patent Document 1, an impedance is increased when a drain current of the FET is reduced.

Patent Document 1: Japanese Laid-Open Patent Publication No. 11-312937

Moreover, there is also a technique in which a signal amplifying circuit for amplifying a converted carrier power is set to be a differential amplifying circuit having a high input impedance and an FET having a high impedance with a low noise is employed for two transistors in an antenna input circuit including a helical antenna of a coil type and the signal amplifying circuit (for example, see Patent Document 2).

Patent Document 2: Japanese Laid-Open Patent Publication No. 10-13149

### DISCLOSURE OF THE INVENTION

In the AM radio receiver using the loop antenna, however, the loop antenna has a low impedance and the tuning effect is small as described above. For this reason, a tuning circuit using a transformer or the like is required for taking the impedance matching. However, it is hard to provide the transformer or the like in an IC chip. For this reason, there is a problem in that the transformer or the like is to be constituted as an external component of the IC chip. It is also possible to propose a method of increasing the impedance of the loop antenna in order to eliminate the necessity of the tuning circuit. However, there is a problem in that a current noise is increased as a result.

In order to solve the problems, it is an object of the present invention to eliminate the necessity of an impedance converting circuit using a transformer or the like without increasing a current noise in a loop antenna input circuit of an AM radio receiver.

In order to attain the object, in the present invention, an amplifying element is directly connected to a loop antenna and a field effect transistor having a low noise and a high input impedance is used as the amplifying element which does not take tuning.

In another aspect of the present invention, a differential amplifying circuit having a high input impedance is used as a signal amplifying circuit using an amplifying element.

According to the present invention having the structure described above, also in the case in which a loop antenna having a low impedance is used, an input signal can be received by a field effect transistor having a high impedance which is directly connected to the loop antenna. Therefore, it is not necessary to use an impedance converting circuit constituted by a transformer or the like for carrying out a conversion into a high impedance. Thus, it is possible to easily integrate an antenna input circuit. Moreover, it is not necessary to increase the impedance of the loop antenna itself. Therefore, it is also possible to prevent a current noise from being made. Furthermore, the differential amplifying circuit constituted by the field effect transistor can lessen the occurrence of the noise, thereby amplifying only the input signal efficiently.

### BRIEF DESCRIPTION OF THE DRAWINGS

FIG. 1 is a diagram showing an example of a partial structure of a conventional AM radio receiver using a loop antenna,

FIG. 2 is a diagram showing an example of a structure of a main part in an AM radio receiver using a loop antenna input circuit according to the present embodiment, and

FIG. 3 is a diagram showing another example of the structure of the main part in the AM radio receiver using the loop antenna input circuit according to the present embodiment.

### BEST MODE FOR CARRYING OUT THE INVENTION

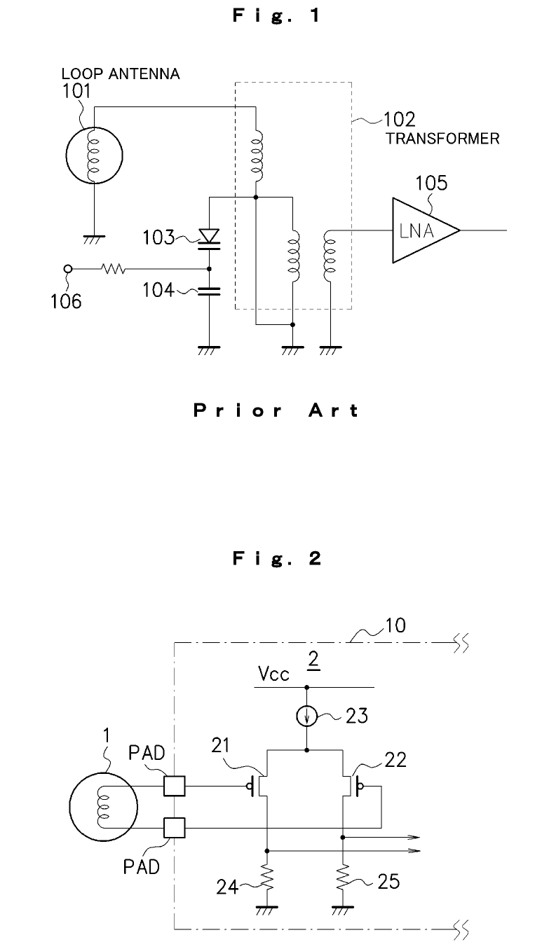

An embodiment according to the present invention will be described below with reference to the drawings. FIG. 2 is a diagram showing an example of a structure of a main part in an AM radio receiver using a loop antenna input circuit according to the present embodiment. As shown in FIG. 2, the AM radio receiver according to the present embodiment includes a loop antenna 1 and a differential amplifier 2 which is directly connected to the loop antenna 1 as a structure of a front end portion thereof. The differential amplifier 2 is integrated into a single IC chip 10 through a CMOS (Complementary Metal Oxide Semiconductor) process or a Bi-CMOS (Bipolar-CMOS) process, for example.

The differential amplifier 2 according to the present embodiment includes two p-MOSFETs (field effect transistors) 21 and 22 to be amplifying elements, a constant current source 23 connected between the p-MOSFETs 21 and 22 and a power supply Vcc, and two resistors 24 and 25 connected between the p-MOSFETs 21 and 22 and grounds. Both of gates of the p-MOSFETs 21 and 22 are connected to the loop antenna 1.

In the present embodiment, thus, the p-MOSFETs 21 and 22 are used as the amplifying elements for amplifying a signal input from the loop antenna 1 and are directly connected to the loop antenna 1. A signal amplifying circuit using the p-MOSFETs 21 and 22 as the amplifying elements is constituted by the differential amplifier 2 setting the p-MOSFETs 21 and 22 to make a differential pair.

According to the AM radio receiver in accordance with the present embodiment which has the structure described above, the signal input from the loop antenna 1 can be received in a high impedance through the p-MOSFETs 21 and 22. Therefore, a transformer or the like for carrying out a conversion into a high impedance is not required so that an antenna input circuit can easily be integrated. Moreover, it is not necessary to increase the impedance of the loop antenna 1 itself. Consequently, it is also possible to suppress the occurrence of a current noise. Furthermore, the p-MOSFETs 21 and 22 to be the amplifying elements and the differential amplifier 2 constituted by using them can lessen the occurrence of a noise, thereby amplifying only the input signal efficiently.

Although the description has been given to the example in which the p-MOSFETs 21 and 22 are used as the amplifying elements in the embodiment, n-MOSFETs may be used. Moreover, it is preferable that the differential amplifier 2 should be set to be an LNA (Low Noise Amplifier) having a small noise to be made and an excellent S/N. In the case in which the p-MOSFETs 21 and 22 are used, there is an advantage that a flicker noise can be reduced more effectively.

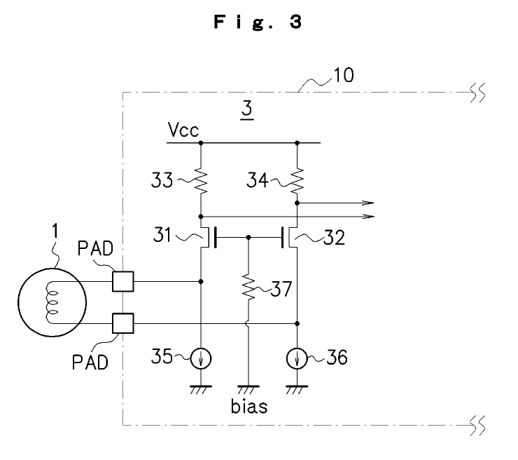

FIG. 3 is a diagram showing another example of the structure of the main part in the AM radio receiver using the loop antenna input circuit according to the present embodiment. The AM radio receiver shown in FIG. 3 includes a loop antenna 1 and an LNA 3 which is directly connected to the loop antenna 1. The LNA 3 is integrated into a single IC chip 10 through a CMOS process or a Bi-CMOS process, for example.

The LNA 3 includes two n-MOSFETs 31 and 32 to be amplifying elements, two resistors 33 and 34 connected between the n-MOSFETs 31 and 32 and a power supply Vcc, two constant current sources 35 and 36 connected between the n-MOSFETs 31 and 32 and grounds, and a bias resistor 37. The loop antenna 1 is connected to drains of the n-MOSFETs 31 and 32. Moreover, both of gates of the n-MOSFETs 31 and 32 are connected to a ground through the bias resistor 37.

In the case in which the n-MOSFETs 31 and 32 are constituted through the gate grounding, thus, an input impedance Zᵢₙ of the IC chip 10 is almost equal to an inverse number of a conductance gₘ of the n-MOSFETs 31 and 32 and can be thus simplified (Zᵢₙ≈1/gₘ). In the present embodiment, the n-MOSFETs 31 and 32 are constituted by the FETs through the CMOS process, for example. Therefore, the conductance gₘ is reduced and the input impedance Zᵢₙ is increased. Therefore, it is possible to easily carry out impedance matching with the loop antenna 1 (a conversion of a low impedance possessed by the loop antenna 1 into a proper high impedance) by regulating the bias resistor 37, thereby setting the conductance gₘ to have an appropriate value.

In addition, the embodiment is only illustrative for a concreteness to carry out the present invention and the technical range of the present invention should not be construed to be restrictive. In other words, the present invention can be carried out in various forms without departing from the spirit or main features thereof.

### INDUSTRIAL APPLICABILITY

The present invention is useful for a broadcasting signal receiving device for receiving a broadcasting signal by using a loop antenna, and particularly an AM radio receiver.

This application is based on Japanese Patent Application No. 2006-260058 filed on Sep. 26, 2006, the contents of which are incorporated hereinto by reference.

What is claimed is:

1. A loop antenna input circuit for AM, wherein an amplifying element for amplifying a signal input from a loop antenna is directly connected to the loop antenna and a field effect transistor is used as the amplifying element.

2. The loop antenna input circuit for AM according to claim 1, wherein the amplifying element is a field effect transistor constituting a differential pair of a differential amplifying circuit.

3. An AM radio receiver comprising:
a loop antenna; and
a signal amplifying circuit in a semiconductor chip which is directly connected to the loop antenna,
wherein a field effect transistor is used as an amplifying element constituting the signal amplifying circuit.
